(19) United States
(12) Patent Application Publication
(10) Pub. No.: US 2010/0214712 A1
(43) Pub. Date: Aug. 26, 2010

(54) METHOD FOR CHARGE-NEUTRALIZING TARGET SUBSTRATE AND SUBSTRATE PROCESSING APPARATUS

(75) Inventors: Jun YAMAWAKU, Nirasaki City (JP); Junji Oikawa, Nirasaki City (JP); Hiroyuki Nakayama, Nirasaki City (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Tokyo (JP)

(21) Appl. No.: 12/710,816

(22) Filed: Feb. 23, 2010

Related U.S. Application Data
(60) Provisional application No. 61/228,656, filed on Jul. 27, 2009.

(30) Foreign Application Priority Data
Feb. 24, 2009 (JP) 2009-041231

(51) Int. Cl. H05F 3/04

(52) U.S. Cl. 361/213

(57) ABSTRACT

A substrate processing apparatus includes a chamber; and a mounting table having an electrostatic attraction portion for electrostatically attracting a target substrate; a heat transfer gas supply system for injecting a heat transfer gas from the electrostatic attraction portion to the target substrate; and a separating unit by which the target substrate is separated from the electrostatic attraction portion. A method for charge-neutralizing a target substrate in the apparatus includes: supplying an ionized gas from the heat transfer gas supply system to the target substrate. The apparatus includes an irradiation unit for irradiating a soft X-ray or an UV beam toward the chamber. In the supplying of the ionized gas, the target substrate is separated from the electrostatic attraction portion by the separating unit, and a soft X-ray or an UV beam is irradiated from the irradiation unit toward a space between the target substrate and the electrostatic attraction portion.

### CROSS-REFERENCE TO RELATED APPLICATIONS

This application claims priority to Japanese Patent Application No. 2009-041231 filed on Feb. 24, 2009, the entire contents of which are incorporated herein by reference.

### FIELD OF THE INVENTION

The present invention relates to a method for charge-neutralizing a target substrate and a substrate processing apparatus; and more particularly, to a method for charge-neutralizing a charged back surface of a substrate as well as a charged surface thereof and a substrate processing apparatus therefor.

### BACKGROUND OF THE INVENTION

Various methods have been suggested to prevent particles from being attached on a wafer for a semiconductor device as a target substrate in a substrate processing apparatus which performs a predetermined plasma treatment, e.g., a plasma etching treatment, on the wafer.

Particles having a diameter of about 100 nm or more have been conventionally required to be prevented from being attached to a wafer and, thus, movements of the particles have been controlled by using the gravity and/or an air flow in the substrate processing apparatus. Since, however, the semiconductor device has recently been getting scaled down, it is needed to form a finer circuit pattern on the wafer. Accordingly, it becomes necessary to manage and control the movements of the particles having diameters ranging from about 30 to 80 nm, which have conventionally been treated as negligible.

In the meantime, as the diameters of the particles get smaller, the particles are dominantly attached by an electrostatic (Coulomb) force rather than the gravity or the inertial force. Accordingly, the particles having the diameters ranging from about 30 to 80 nm are attached on the wafer and/or elements, e.g., an inner wall of a chamber, in the substrate processing apparatus.

FIG. 8 is a graph showing relationships between a diameter of a particle and an adhesive strength thereof. In FIG. 8, the vertical axis indicates an adhesive strength (deposition velocity) (cm/s) and the horizontal axis indicates the diameter of the particle. As described above, as the diameter of the particle gets smaller, an adhesive strength is dominantly affected by the electrostatic force. Accordingly, to prevent the particles from being attached on the wafer or the like, it is essential to maintain the particles and/or the wafer not to be charged or charge-neutralize the charged particles and/or the charged wafer.

As described above, such a static electricity can cause for the particles to be attached on the wafer or the like and furthermore, can cause to inflict a damage on the semiconductor device. For example, by the static electricity of about 1000 V, the semiconductor device may be damaged.

Moreover, in the substrate processing apparatus employing an electrostatic chuck (ESC) for electrostatically attracting a wafer thereon, if the wafer is electrostatically attracted on the electrostatic chuck for a long time, the wafer becomes charged. In this case, when charges in the wafer are released to other parts, the wafer may be damaged or a discharge trace may remain in the wafer. As a result, the production yield may be lowered. Therefore, by charge-neutralizing the charged wafer, it is possible to prevent the particles from being attached and the wafer from being damaged.

There has been a well known technique to remove particles attached on an inner wall of a chamber by employing an electrostatic force (see, e.g., Japanese Patent Application Publication No. 2002-353086)). According to the technique, a charge-neutralizing device for generating an ion flow is arranged in a chamber (air lock chamber in the Japanese patent application).

Here, by the charge-neutralizing device, the ions forming the ion flow are released to the chamber and particles attached on an inner wall of the chamber are separated from the inner wall thereof by charge-neutralizing (removing the static electricity) the particles by use of the ions. Then, the particles are removed by exhausting an air inside the chamber to the outside by an exhaust device.

There has been a widely known technique to charge-neutralize a charged wafer, in which a plasma is generated and charges accumulated on the wafer are neutralized by bringing electrons and/or positive ions in the plasma into contact with the charged wafer.

When a wafer W is electrostatically attracted on an electrostatic chuck, if a positive voltage is applied to an electrode plate in the electrostatic chuck, negative charges are accumulated on a surface (referred to as “back surface” hereinafter) of the wafer W on the side of the electrostatic chuck. In contrast, positive charges are accumulated on a surface (referred to as “front surface” hereinafter) on the opposite side of the back surface of the wafer W.

In the Japanese Patent application and such a method for charge-neutralization using a plasma, since the ions in the ion flow and/or the plasma can be brought into contact only with the front surface of the wafer W, the positive charges accumulated on the surface only can be neutralized to be removed.

Since, however, the back surface of the wafer W is brought into contact with the electrostatic chuck, the back surface is not exposed to the ions and/or the plasma and, thus, the negative charges accumulated on the back surface are not neutralized. In other words, the back surface of the wafer W is not charge-neutralized. As a result, it becomes difficult to prevent the particles from being attached on the wafer W and the wafer W from being damaged when the wafer W is unloaded, for example.

### SUMMARY OF THE INVENTION

In view of the above, the present invention provides a method for charge-neutralizing a target substrate and a substrate processing apparatus, capable of preventing particles from being attached on the target substrate and the target substrate from being damaged.

In accordance with an aspect of the present invention, there is provided a method for charge-neutralizing a target substrate in a substrate processing apparatus including a chamber for accommodating the target substrate therein; and a mounting table for mounting the target substrate thereon, the mounting table having an electrostatic attraction portion for electrostatically attracting the target substrate; and a heat transfer gas supply system for injecting a heat transfer gas from the electrostatic attraction portion to the target substrate. The method includes: supplying an ionized gas from the heat transfer gas supply system to the target substrate.

In accordance with another aspect of the present invention, there is provided a method for charge-neutralizing a target substrate in a substrate processing apparatus including a chamber for accommodating the target substrate therein; and a mounting table for mounting the target substrate thereon, the mounting table having an electrostatic attraction portion for electrostatically attracting the target substrate; a heat transfer gas supply system for injecting a heat transfer gas from the electrostatic attraction portion to the target substrate; and a separating unit by which the target substrate is separated from the electrostatic attraction portion. The method includes: supplying an ionized gas from the heat transfer gas supply system to the target substrate. The substrate processing apparatus includes an irradiation unit for irradiating a soft X-ray or an UV (ultraviolet) beam toward an inside of the chamber; and, in the supplying of the ionized gas, the target substrate is separated from the electrostatic attraction portion by the separating unit, and a soft X-ray or an UV beam is irradiated from the irradiation unit toward a space between the target substrate and the electrostatic attraction portion.

In accordance with still another aspect of the present invention, there is provided a substrate processing apparatus including a chamber for accommodating the target substrate therein; and a mounting table for mounting the target substrate thereon, the mounting table having an electrostatic attraction portion for electrostatically attracting the target substrate, and a heat transfer gas supply system for injecting a heat transfer gas from the electrostatic attraction portion to the target substrate. An ionized gas is supplied from the heat transfer gas supply system to the target substrate.

In accordance with still another aspect of the present invention, there is provided a substrate processing apparatus including a chamber for accommodating the target substrate therein; and a mounting table for mounting the target substrate thereon, the mounting table having an electrostatic attraction portion for electrostatically attracting the target substrate; a heat transfer gas supply system for injecting a heat transfer gas from the electrostatic attraction portion to the target substrate; and a separating unit by which the target substrate is separated from the electrostatic attraction portion. The apparatus further includes: an irradiation unit for irradiating a soft X-ray or an UV beam toward an inside of the chamber. A predetermined gas is supplied from the heat transfer gas supply system toward the target substrate. When the predetermined gas is supplied toward the target substrate, the target substrate is separated from the electrostatic attraction portion by the separating unit. A soft X-ray or an UV beam is irradiated from the irradiation unit toward a space between the target substrate and the electrostatic attraction portion.

### BRIEF DESCRIPTION OF THE DRAWINGS

The objects and features of the present invention will become apparent from the following description of embodiments, given in conjunction with the accompanying drawings, in which:

FIG. 1 is a schematic sectional view showing a structure of a substrate processing apparatus which performs a method for charge-neutralizing a target substrate in accordance with a first embodiment of the present invention;

FIGS. 2A to 2D are plan views showing an electrostatic chuck; specifically, FIG. 2A shows how heat transfer gas injection holes are arranged in the electrostatic chuck; FIG. 2B shows how ionized gas flows in a wafer charge-neutralizing treatment shown in FIGS. 3A to 3E; FIG. 2C shows how an ionized gas flows in a second modification of the wafer charge-neutralizing treatment shown in FIGS. 3A to 3E; and FIG. 2D shows how an ionized gas flows in a third modification of the wafer charge-neutralizing treatment shown in FIGS. 3A to 3E;

FIGS. 3A to 3E successively show the wafer charge-neutralizing treatment as the method for charge-neutralizing a target substrate in accordance with the first embodiment of the present invention;

FIGS. 4A to 4D successively show a first modification of the wafer charge-neutralizing treatment shown in FIGS. 3A to 3E;

FIGS. 5A and 5B show other modifications of the wafer charge-neutralizing treatment shown in FIGS. 3A to 3E; specifically, FIG. 5A shows the second modification of the wafer charge-neutralizing treatment shown in FIGS. 3A to 3E; and FIG. 5B shows the third modification of the wafer charge-neutralizing treatment shown in FIGS. 3A to 3E;

FIG. 6 is a schematic sectional view showing a structure of a substrate processing apparatus which performs a method for charge-neutralizing a target substrate in accordance with a second embodiment of the present invention;

FIGS. 7A to 7C successively show the wafer charge-neutralizing treatment as the method for charge-neutralizing a target substrate in accordance with the second embodiment of the present invention; and

FIG. 8 is a graph showing relationships between a diameter of a particle and an adhesive strength thereof.

### DETAILED DESCRIPTION OF THE EMBODIMENTS

Embodiments of the present invention will now be described in detail with reference to the accompanying drawings which form a part hereof.

First, a method for charge-neutralizing a target substrate in accordance with a first embodiment of the present invention will be described.

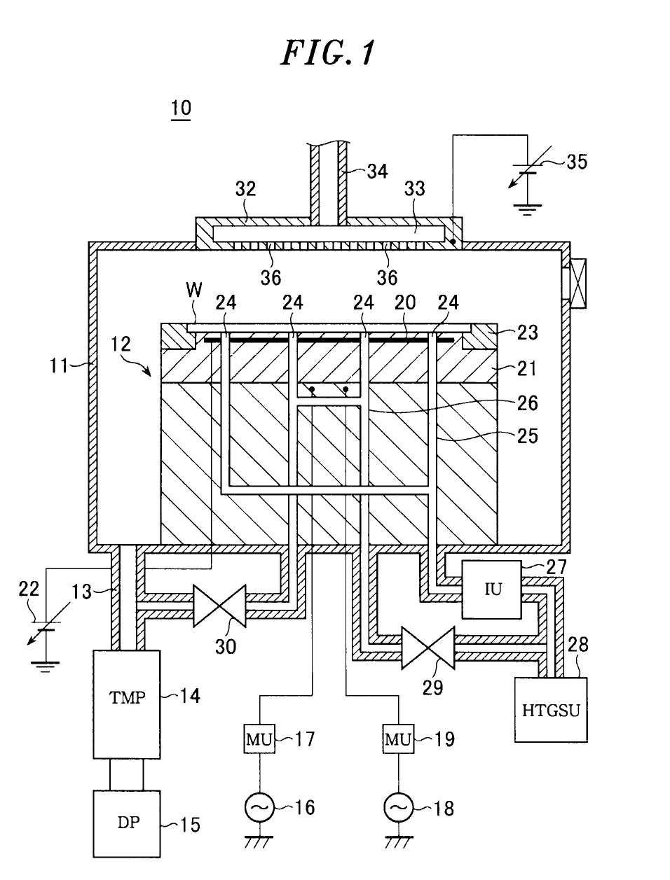

FIG. 1 is a schematic sectional view showing a structure of a substrate processing apparatus 10 which performs the method for charge-neutralizing a target substrate in accordance with the first embodiment of the present invention. The substrate processing apparatus 10 is configured to perform a dry etching treatment on a wafer.

As shown in FIG. 1, the substrate processing apparatus 10 includes a chamber 11 (accommodation chamber) for accommodating therein a wafer W (target substrate) having a diameter of, e.g., 300 mm. Arranged in the chamber 11 is a cylindrical susceptor 12 (mounting table) for mounting the wafer W thereon.

An exhaust pipe 13 is connected to a lower portion of the chamber 11 to exhaust any gas in the chamber 11 therethrough. Connected to the exhaust pipe 13 are a turbo molecular pump (TMP) 14 and a dry pump (DP) 15, which are used to exhaust the inside of the chamber 11 to a vacuum level.

Specifically, the DP 15 lowers the pressure inside the chamber 11 from an atmospheric pressure to a medium vacuum state (e.g., 1.3×10 Pa (0.1 Torr) or less) and the TMP 14 cooperates with the DP 15 to further lower the pressure inside the chamber 11 from the medium vacuum state to a high vacuum state (e.g., 1.3×10⁻³ Pa (1.0×10⁻⁵ Torr) or less). The pressure inside the chamber 11 is controlled by an automatic pressure control (APC) valve.

A first high frequency power supply 16 and a second high frequency power supply 18 are connected to the susceptor 12 inside the chamber 11 via a first matching unit (MU) 17 and a second matching unit (MU) 19, respectively.

A high frequency voltage for plasma attraction (hereinafter, referred to as a bias voltage) having a relatively low frequency is applied from the first high frequency power supply 16 to the susceptor 12, and a high frequency voltage for plasma generation (hereinafter, referred to as a plasma generation voltage) having a relatively high frequency is applied from the second high frequency power supply 18 to the susceptor 12. Accordingly, the susceptor 12 serves as an electrode.

Meanwhile, by the first and the second matching unit 17 and 19, the return of the high frequency voltage from the susceptor 12 is suppressed.

Arranged at an upper portion of the susceptor 12 is an electrostatic chuck 21 (electrostatic attraction portion) having an electrostatic electrode plate 20 therein. The electrostatic chuck 21 has a shape in which a top circular plate shaped member is stacked on a bottom circular plate shaped member, wherein a diameter of the top circular plate shaped member is smaller than that of the bottom circular plate shaped member. The top and the bottom circular plate shaped member of the electrostatic chuck 21 may be made of a ceramic.

A first DC power supply 22 is connected to the electrostatic electrode plate 20 in the electrostatic chuck 21. When the wafer W is mounted on the electrostatic electrode plate 20 by being brought into contact therewith, if a positive DC voltage is applied to the electrostatic electrode plate 20 to generate a positive potential, negative charges are induced, by the positive potential, on a surface (hereinafter, referred to as “back surface”) of the wafer W on the side of the electrostatic chuck 21.

Here, since the electrostatic chuck 21 is made of a ceramic, the induced negative charges remain on the back surface of the wafer W without moving to the electrostatic chuck 21, thereby generating a negative potential thereon. As a result, a potential difference is developed between the electrostatic electrode plate 20 and the back surface of the wafer W and, by a Coulomb force or a Johnson-Rahbek force generated by the potential difference, the wafer W is attracted to and held on the top circular plate shaped member of the electrostatic chuck 21.

A ring-shaped focus ring 23 is mounted on the electrostatic chuck 22 to surround the wafer W attracted and held on the electrostatic chuck 21. The focus ring 23 is made of a conductor, e.g., a single crystalline silicon, same as the material of the wafer W.

Since the focus ring 23 is made of a conductor, a distribution region of the plasma is extended to a region above the focus ring 23 in addition to the region above the wafer W and the density of the plasma at a peripheral portion of the wafer W is maintained to be identical to that of the plasma at a center portion of the wafer W. Accordingly, it is possible to maintain the uniformity of the dry etching treatment over the entire surface of the wafer W.

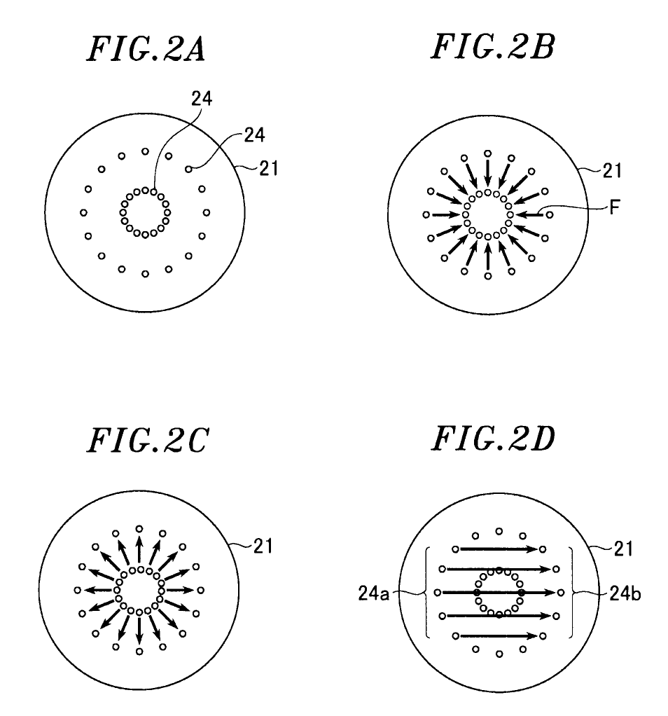

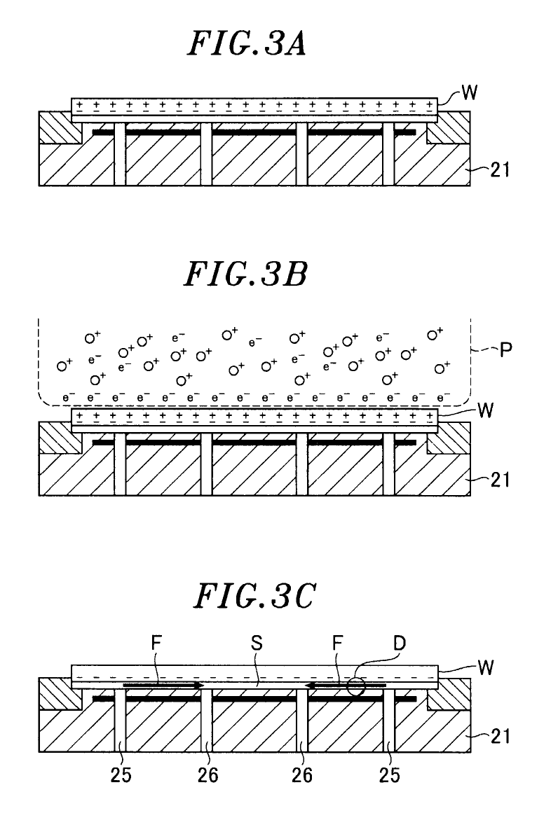

A plurality of heat transfer gas injection holes 24 which are open toward the wafer W mounted on the mounting table 12 is dispersedly arranged at a region (hereinafter, referred to as an attraction surface), in which the wafer W is attracted and held, of a top surface of the top circular plate shaped member of the electrostatic chuck 21 (FIG. 2A). A group of the heat transfer gas injection holes 24 arranged at a peripheral portion of the attraction surface is connected to a peripheral heat transfer gas supply system 25, and another group of the heat transfer gas injection holes 24 arranged at a central portion of the attraction surface is connected to a central heat transfer gas supply system 26.

The peripheral heat transfer gas supply system 25 is arranged inside the mounting table 12 and has a plurality of gas supply holes extending through the electrostatic chuck in a thickness direction thereof. The peripheral heat transfer gas supply system 25 is also connected, via an ionization unit (IU) 27, to a heat transfer gas supply unit (HTGSU) 28, which is provided outside the chamber 11.

Similarly, the central heat transfer gas supply system is arranged inside the mounting table 12 and has a plurality of gas supply holes extending through the electrostatic chuck 21 in a thickness direction thereof. The central heat transfer gas supply system 26 is also connected to the heat transfer gas supply unit 28 via a valve 29 and to the exhaust pipe 13 via a valve 30. A heat transfer gas supply system includes the peripheral and the central heat transfer gas supply system 25 and 26.

A heat transfer gas, e.g., He gas, is supplied from the heat transfer gas supply unit 28 to the heat transfer gas supply system. Through the heat transfer gas supply system, the heat transfer gas is injected to the back surface of the wafer W electrostatically attracted on the electrostatic chuck 21. The injected heat transfer gas is filled in a gap between the wafer W and the attraction surface, to thereby improve the heat transfer property from the wafer W to the electrostatic chuck 21 (mounting table 12).

The mounting table 12 has a plurality of lifter pins 31 (separating units) that is freely protruding from the attraction surface of the electrostatic chuck 21. After the wafer W is stopped to be electrostatically attracted on the electrostatic chuck 21, the lifter pins 31 are protruding from the attraction surface to separate the wafer W from the electrostatic chuck 21, thereby lifting up the wafer W.

At a ceiling portion of the chamber 11, a shower head 32 is arranged to face the susceptor 12. A buffer chamber is provided inside the shower head 32 and a processing gas supply line 34 is connected to the buffer chamber 33. Moreover, a second DC power supply 35 is connected to the shower head 32 to supply a negative DC voltage, for example, thereto. The buffer chamber 33 of the shower head 32 communicates with the chamber 11 through a plurality of gas holes 36.

In the substrate processing apparatus 10, a processing gas supplied through the processing gas supply line 34 to the buffer chamber 33 is introduced into the chamber 11 through the gas holes 36. Then, the introduced processing gas is excited, to be converted to a plasma, by a plasma generation voltage applied from the second high frequency power supply 18 to the chamber 11 through the susceptor 12. Positive ions in the plasma are attracted to the wafer W by a bias voltage, applied from the first high frequency power supply 16 to the susceptor 12, to be used to perform a dry etching treatment on the wafer W.

In the substrate processing apparatus 10, during the dry etching treatment, a negative DC voltage is applied from the second DC power supply 35 to the shower head 32. At this time, the positive ions in the plasma are attracted to the shower head 32. The attracted positive ions impart energies to electrons of constituent atoms of the shower head 32. When the energy imparted to an electron of a constituent atom is larger than a predetermined value, the electron of the constituent atom is released as a secondary electron from the shower head 32. Accordingly, the electron density inside the chamber 11 is adjusted.

Operations of various elements in the substrate processing apparatus 10 are controlled by a central processing unit (CPU) of a controller (not shown) therein with a predetermined program.

While the substrate processing apparatus 10 performs the dry etching treatment on the wafer W, the wafer W remains to be electrostatically attracted on the electrostatic chuck 21. Accordingly, negative charges continuously remain on the back surface of the wafer W. Moreover, positive charges are reactively induced on a surface (hereinafter, referred to as “front surface”) of the wafer W, on the opposite side of the back surface thereof, to remain thereon continuously. As a result, the negative charges are accumulated on the back surface of the wafer W, and the positive charges are accumulated on the front surface thereof.

An electrostatic force caused by the charges accumulated on the front surface and/or the back surface of the wafer W can attract floating fine particles inside the chamber 11 to thereby cause an abnormal discharge between the wafer W and an arm for transferring the wafer W or other elements, when the wafer W is lifted up from the electrostatic chuck 21 by the lifter pins 31 after the plasma etching treatment is ended, for example.

To deal with the above problem, in accordance with the method for charge-neutralizing a target substrate of the first embodiment, the charges accumulated on the front surface and/or the back surface of the wafer W can be neutralized by using a plasma and/or an ionized gas.

In the substrate processing apparatus 10, the ionization apparatus 27 ionizes a gas supplied from the heat transfer gas supply unit 28 by using various methods such as corona discharge, UV beam irradiation, soft X-ray irradiation and/or the like to generate an ionized gas. Specifically, as the soft X-ray is irradiated to, e.g., a nitrogen gas, electrons are released from the nitrogen atoms to generate positive ions. As a result, the ionized gas containing the positive ions and negative ions having the same amount as the positive ions is generated.

A source gas for the ionized gas may be at least one of dry air, inert gas such as argon gas, and oxygen gas as well as the nitrogen gas. The ionized gas generated by the ionization unit 27 is injected toward the wafer W on the electrostatic chuck 21 by the peripheral heat transfer gas supply system 25.

Hereinafter, a wafer charge-neutralizing treatment as the method for charge-neutralizing a target substrate in accordance with the first embodiment of the present invention will be described.

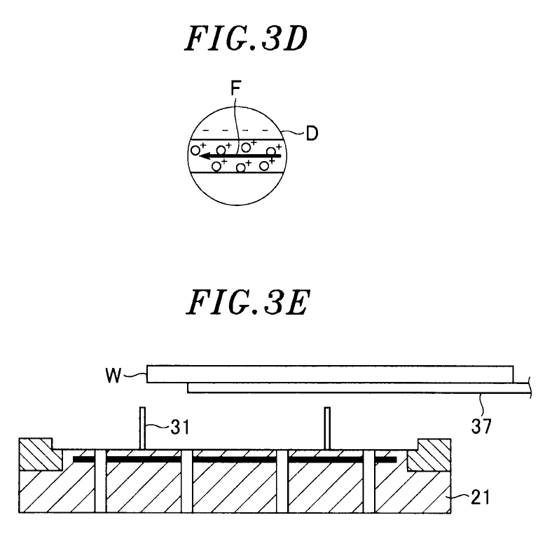

FIGS. 3A to 3E successively show the wafer charge-neutralizing treatment as the method for charge-neutralizing a target substrate in accordance with the first embodiment of the present invention.

In the wafer charge-neutralizing treatment, the electrostatic attraction of the wafer W charged during the plasma etching treatment is first stopped (FIG. 3A). At this time, the positive and the negative charges are accumulated on the front surface and the back surface, respectively, of the wafer W.

Successively, a plasma P is generated inside the chamber 11. Electrons (illustrated as “e⁻” in FIG. 3B) in the plasma p are attracted on the front surface of the wafer W by a positive potential generated thereon. The front surface of the wafer W is charge-neutralized by neutralizing positive charges accumulated thereon with the attracted electrons (FIG. 3B).

Then, an ionized gas is injected from the peripheral heat transfer gas supply system 25 toward the back surface of the wafer W (ionized gas supply process). At this time, the valve 29 is closed and the valve 30 is opened. If the valve 29 is closed, no gas is supplied from the heat transfer gas supply unit 28 to the central heat transfer gas supply system 26. Moreover, if the valve 30 is opened, the central heat transfer gas supply system 26 communicates with the TMP 14 via the exhaust pipe 13.

Accordingly, the central heat transfer gas supply system 26 serves as an absorption system for absorbing a gas around the back surface of the wafer W through the heat transfer gas injection holes 24. As a result, the ionized gas flows from the heat transfer gas supply system 25 to the central heat transfer gas supply system 26 as pointed by an arrow F shown in FIG. 3C in a space S between the wafer W and the electrostatic chuck 21 (FIGS. 3C and 2B). Therefore, the ionized gas is dispersed over an entire area of the space S, to thereby be brought into contact with most area of the back surface of the wafer W.

Moreover, as shown in FIG. 3D, which is an enlarged view of FIG. 3C, the negative charges accumulated on the back surface of the wafer W are neutralized by using the positive ions (illustrated as “O⁺” in FIG. 3D) in the ionized gas that is brought into contact with the back surface of the wafer W. Further, to completely remove the accumulated negative charges, it is preferable to prevent the number of negative ions from being reduced by continuously supplying the ionized gas through the heat transfer gas injection holes 24.

Meanwhile, when the ionized gas is injected from the peripheral heat transfer gas supply system 25, the wafer W may be bounced up since the pressure in the space S (neighborhood of an electrostatic attraction portion of the wafer W) gets higher than that in a neighborhood of the front surface of the wafer W.

Accordingly, in the present embodiment, the valve 30 is opened at an adequate angle and the TMP 14 is operated at an adequate rotation rate such that the amount of gas absorbed by the central heat transfer supply system 26 is larger than that of ionized gas injected from the peripheral heat transfer gas supply system 25. Accordingly, the pressure inside the space S becomes lower than a pressure around the front surface of the wafer W.

Then, the wafer W is lifted up from the electrostatic chuck 21 by the lifter pins 31 and a transfer arm 37 is moved to the inside of the chamber 11. Then, the charge-neutralized wafer W is unloaded to the outside of the chamber 11 (FIG. 3E) to end this treatment.

In accordance with the wafer charge-neutralizing treatment shown in FIGS. 3A to 3E, after the positive charges accumulated on the front surface of the wafer W are neutralized by the plasma P, the ionized gas is injected from the peripheral heat transfer gas supply system 25 toward the back surface of the wafer W. For that reason, the positive ions of the injected ionized gas are brought into contact with the back surface of the wafer W.

Accordingly, the positive and the negative charges accumulated on the front surface and the back surface, respectively, of the wafer W can be removed. As a result, the wafer W can be certainly charge-neutralized. This can make it possible to prevent particles from being attached on the wafer W and the wafer W from being damaged by abnormal discharge.

Moreover, in accordance with the wafer charge-neutralizing treatment shown in FIGS. 3A to 3E, since the ionized gas is injected through the heat transfer gas injection holes 24 that are open toward the back surface of the wafer W, the ionized gas can be brought into contact with the back surface of the wafer W compactly.

In the meantime, in the wafer charge-neutralizing treatment shown in FIGS. 3A to 3E, since the amount of gas absorbed by the central heat transfer supply system 26 is larger than that of ionized gas injected from the peripheral heat transfer gas supply system 25, the pressure inside the space S becomes lower than a pressure around the front surface of the wafer W, thereby allowing the wafer W to be attracted toward the electrostatic chuck 21. Accordingly, the wafer W can be prevented from being bounced up from the electrostatic chuck 21 and, thus, being damaged.

Further, in accordance with the wafer charge-neutralizing treatment shown in FIGS. 3A to 3E, the ionized gas is injected from the peripheral heat transfer gas supply system 25, and the gas around the back surface of the wafer W is absorbed by the central heat transfer gas supply system 26.

Accordingly, since the pressure is increased at a portion of the space S corresponding to a peripheral portion of the attraction surface, a gas can be prevented from flowing from an outside into the space S, so that the ionized gas can be prevented from being diluted. As a result, it is possible to efficiently remove the negative charges accumulated on the back surface of the wafer W.

In the aforementioned substrate processing apparatus 10, by the electrostatic attraction of the wafer W, the electrostatic chuck 21 as well as the wafer W may be charged. However, each of the peripheral and the central heat transfer gas supply system 25 and 26 has a plurality of gas supply holes that extend through the electrostatic chuck 21 in a thickness direction thereof, and the ionized gas is injected through the gas supply holes. Accordingly, when the ionized gas is injected, it is possible to charge-neutralize the electrostatic chuck as well as the wafer W.

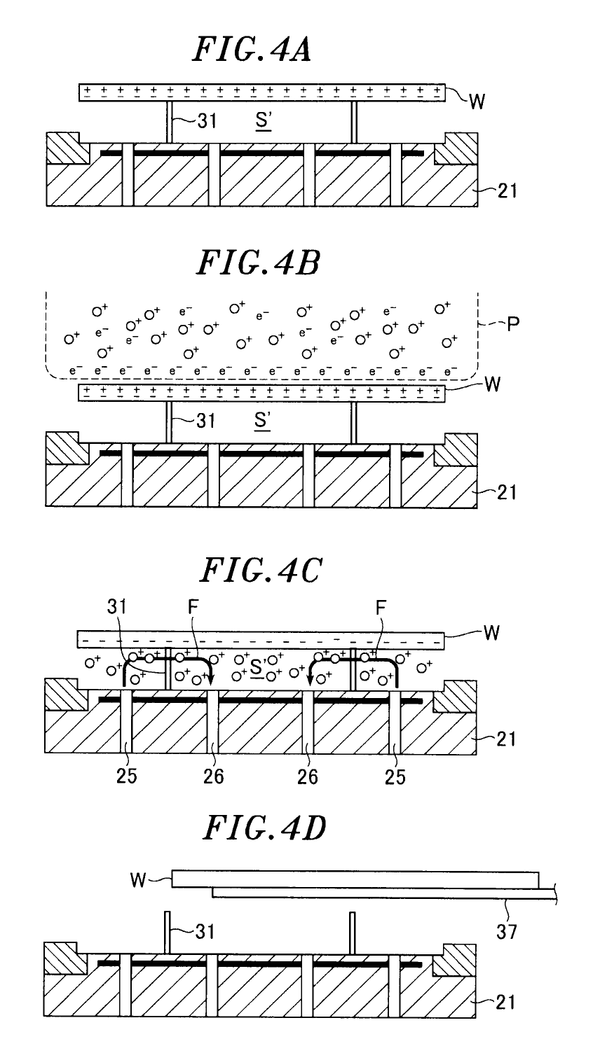

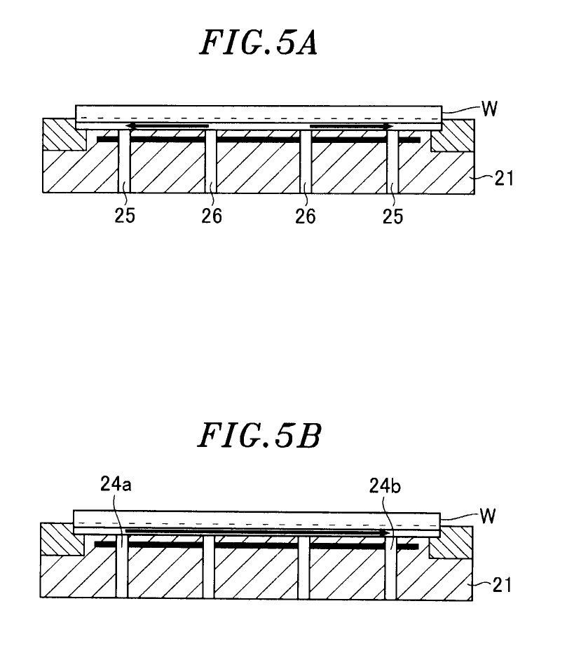

In accordance with the wafer charge-neutralizing treatment shown in FIGS. 3A to 3E, when the wafer W is charge-neutralized, the wafer W is not separated from the electrostatic chuck 21. However, the wafer W may be separated from the electrostatic chuck 21 by the lifter pins 31 (FIGS. 4A to 4D) while the wafer W is charge-neutralized.

In this case, it is possible to enlarge a space s′ between the wafer W and the electrostatic chuck 21, to thereby increase a conductance for the flow of ionized gas in the space S′. As a result, since the ionized gas injected from the electrostatic chuck 21 to the wafer W is diffused in the space S′, the ionized gas can be brought into contact with most area of the back surface of the wafer W.

Moreover, in the wafer charge-neutralizing treatment shown in FIGS. 3A to 3E, the ionized gas is injected from the peripheral heat transfer gas supply system 25, and the gas around the back surface of the wafer W is absorbed by the central heat transfer gas supply system 26. Alternatively, the structure of the heat transfer gas supply system may be changed to inject the ionized gas from the central heat transfer gas supply system 26 and absorb the gas around the back surface of the wafer W by the peripheral heat transfer gas supply system 25 (FIG. 5A).

In this case, the ionized gas can be radially diffused from a central portion to a peripheral portion in the space S (FIG. 2C), thereby improving the uniformity of the concentration of ionized gas in the space S. As a result, it is possible to uniformly neutralize the negative charges accumulated on the back surface of the wafer W.

Further alternatively, the ionized gas may be injected from a group 24a of the heat transfer gas injection holes 24 located around one side of the attraction surface, and the gas may be absorbed by another group 24b of the heat transfer gas injection holes 24 located around the other side of the attraction surface (FIGS. 5B and 2D). In this case, it is possible to make a uniform flow of the ionized gas and uniformly neutralize the negative charges accumulated on the back surface of the wafer W.

In the aforementioned charge-neutralization treatment, the plasma P is used to neutralize the positive charges accumulated on the front surface of the wafer W. Alternatively, the positive charges may be neutralized by releasing a flow of ions from a charge-neutralizing device to the chamber 11.

In the first embodiment, the positive and the negative charges are accumulated on the front surface and the back surface, respectively, of the wafer W. However, when the wafer W is electrostatically attracted by applying a negative DC voltage to the electrostatic plate 20, negative and positive charges are accumulated on the surface and the back surface, respectively, of the wafer W.

In this case, the negative charges accumulated on the front surface of the wafer W may be neutralized by using the positive ions in the plasma P, and the positive charges accumulated on the back surface of the wafer W may be neutralized by using the negative ions in the ionized gas. Accordingly, the wafer W can be charge-neutralized by using the wafer charge-neutralizing treatment shown in FIGS. 3A to 3E.

Successively, a method for charge-neutralizing a target substrate in accordance with a second embodiment of the present invention will be described.

The second embodiment has a basically same structure and operations as the first embodiment except for a different feature in which the ionization unit is not used. Accordingly, only the different features will be described and any redundant description will not be repeated.

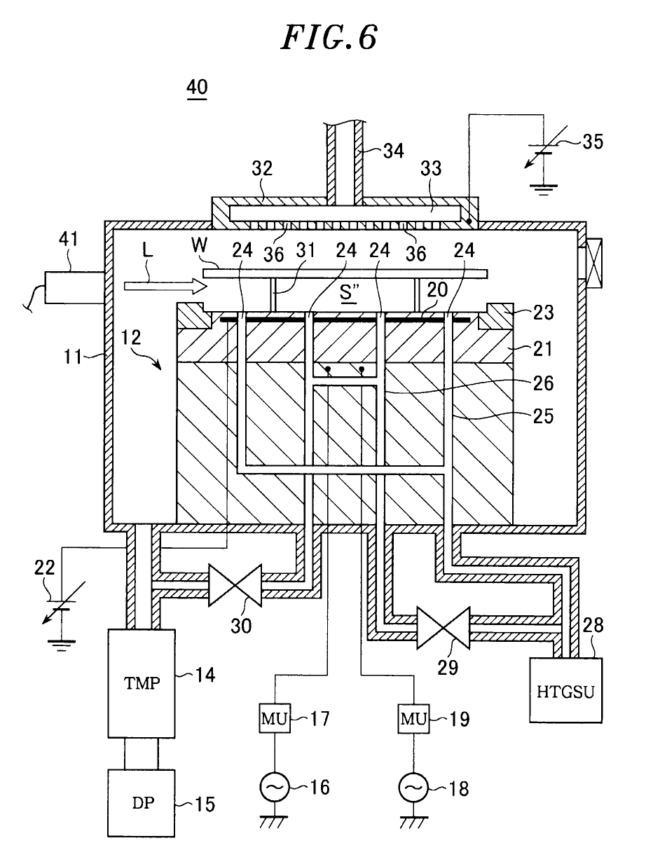

FIG. 6 is a schematic sectional view showing a structure of a substrate processing apparatus 40 which performs the method for charge-neutralizing a target substrate in accordance with the second embodiment of the present invention.

As shown in FIG. 6, the substrate processing apparatus 40 includes a soft X-ray irradiation unit 41 arranged on a sidewall of the chamber 11. A soft X-ray L is irradiated from the soft X-ray unit to a space S″ between the electrostatic chuck 21 and the wafer W that has been lifted up by the lifter pins 31.

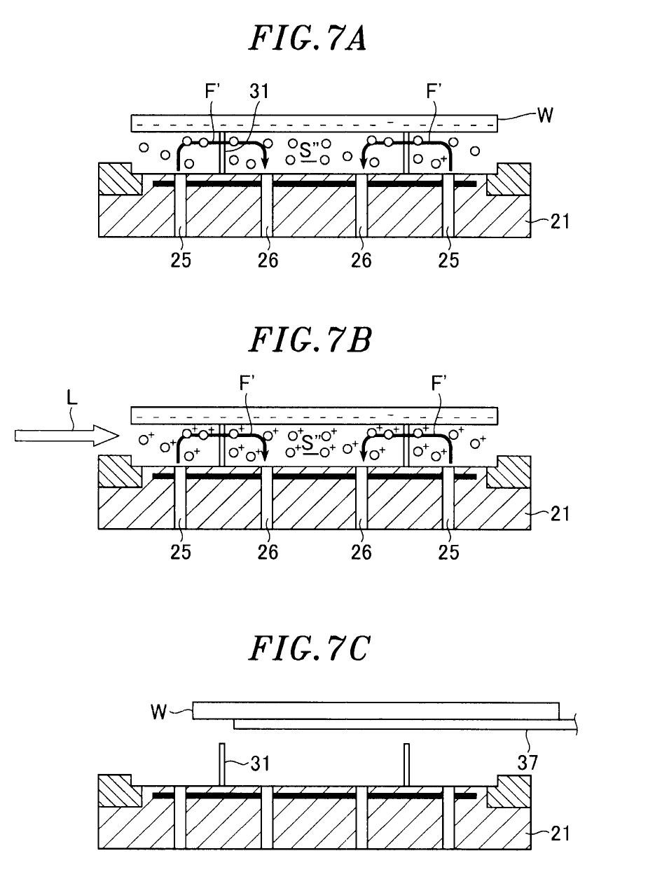

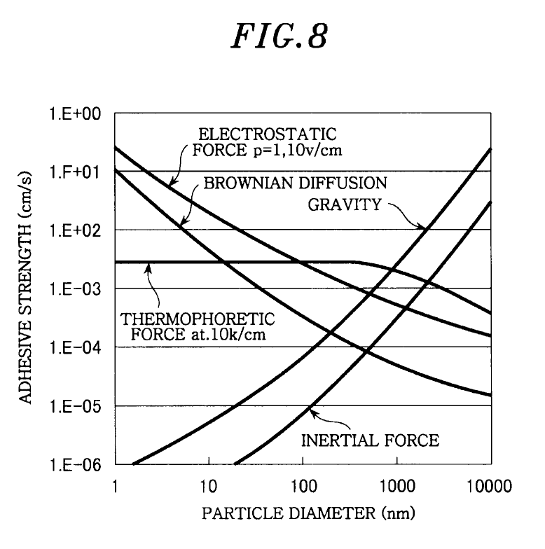

FIGS. 7A to 7C successively show the wafer charge-neutralizing treatment as the method for charge-neutralizing a target substrate in accordance with the second embodiment of the present invention.

In the wafer charge-neutralizing treatment shown in FIGS. 7A to 7C, the wafer W that has been charged during the plasma etching treatment is lifted up from the electrostatic chuck 21 by the lifter pins 31, and positive charges accumulated on a front surface of the wafer W is neutralized by using electrons in the plasma P.

Successively, an inert gas, e.g., nitrogen gas (a predetermined gas) (illustrated as “O” in FIG. 7A), is injected from the peripheral heat transfer gas supply system 25 to the back surface of the wafer W (predetermined gas supply process); and the central heat transfer gas supply system 26 communicates with the TMP 14 to serve as an absorbing system for absorbing a gas around the back surface of the wafer W. As a result, the nitrogen gas flows from the peripheral heat transfer gas supply system 25 to the central heat transfer gas supply system 26 in the space S″ as pointed by an arrow F′ (FIG. 7A).

Then, a soft X-ray L is irradiated from the soft X-ray irradiation unit 41 to the space S″ and, thus, the nitrogen gas is ionized to generate an ionized gas. At this time, positive ions (illustrated as “O⁺” in FIG. 7B) in the ionized gas is dispersed over an entire area of the space S as pointed by the arrow F′. Accordingly, the dispersed ionized gas is brought into contact with most area of the back surface of the wafer W, thereby neutralizing negative charges accumulated on the back surface of the wafer W (FIG. 7B).

Moreover, in a same way as in the wafer charge-neutralizing treatment shown in FIGS. 3A to 3E, the pressure inside the space S″ is set to be lower than the pressure around the surface of the wafer W by allowing the amount of gas absorbed by the central heat transfer supply system 26 to be larger than that of ionized gas injected from the peripheral heat transfer gas supply system 25.

Then, the transfer arm 37 is moved to the inside of the chamber 11 and the charge-neutralized wafer W is unloaded to the outside of the chamber 11 (FIG. 7C) to end this treatment.

In accordance with the wafer charge-neutralizing treatment shown in FIGS. 7A to 7C, after the positive charges accumulated on the front surface of the wafer W are neutralized by the plasma P, the soft X-ray L is irradiated to the nitrogen gas injected from the peripheral heat transfer gas supply system 25 to the back surface of the wafer W in the space S. By the soft X-ray irradiated to the nitrogen gas, an ionized gas is generated from the nitrogen gas. The positive ions in the ionized gas are brought into contact with the back surface of the wafer W. As a result, it is possible to yield the same effect as the first embodiment.

Further, when the ionized gas is generated, if the soft X-ray L is irradiated toward the wafer W, various films formed on the wafer W may be damaged. However, in the wafer charge-neutralizing treatment shown in FIGS. 7A to 7C, the soft X-ray L is merely irradiated to the space S between the wafer W and the electrostatic chuck 21, so that the films formed on the wafer W can be prevented from being damaged.

Although the nitrogen gas is employed to generate the ionized gas in the wafer charge-neutralizing treatment shown in FIGS. 7A to 7C, oxygen gas or other inert gases such as dry air, argon gas and the like may be alternatively employed. Moreover, even if the negative and the positive charges are accumulated on the front surface and the back surface, respectively, of the wafer W, the wafer W can be charge-neutralized as in the first embodiment.

Even though the soft X-ray irradiation unit 41 is employed in the aforementioned substrate processing apparatus 40, an UV beam irradiation unit for irradiating an UV beam toward the space S can be alternatively employed in the substrate processing apparatus 40 instead of the soft X-ray irradiation unit 41. Since the ionized gas is generated from the nitrogen gas by the UV beam irradiated to the nitrogen gas in the space S, it is possible to yield the same effect as in the first embodiment.

Although the substrate to be subjected to the dry etching process is a wafer for semiconductor devices in the respective embodiments, the substrate is not limited thereto. For example, the substrate may be a glass substrate for use in a liquid crystal display (LCD) or a flat panel display (FPD).

The purpose of the present invention can be also achieved by providing a computer (e.g. a controller) with a storage medium storing program codes of software realizing the operations of the respective embodiments and allowing a central processing unit (CPU) of the computer to read and execute the program codes stored in the storage medium.

In this case, the program codes themselves read from the storage medium realize the functions of the respective embodiments, and thus the present invention includes the program codes and the storage medium storing the program codes.

The storage medium for providing the program codes may be, e.g., a RAM, an NV-RAM, a floppy (registered trademark) disk, a hard disk, a magneto-optical disk, an optical disk such as CD-ROM, CD-R, CD-RW, and DVD (DVD-ROM, DVD-RAM, DVD-RW, and DVD+RW), a magnetic tape, a nonvolatile memory card, or other types of ROM capable of storing the program codes. The program codes may be provided to the computer by being downloaded from another computer or a database, which is not shown, connected to the Internet, a commercial use network, a local area network, or the like.

The operations of the respective embodiments can be realized by executing the program codes read by the computer or by the actual processing partially or wholly executed by an operating system (OS) operated on the CPU in accordance with the instructions of the program codes.

In addition, the operations may also be realized by the actual processing partially or wholly executed by a CPU or the like in a built-in function extension board or an external function extension unit of a computer in accordance with the instructions of program codes read from a storage medium after the program codes are inputted into a memory in the built-in function extension board or the external function extension unit.

While the invention has been shown and described with respect to the embodiments, it will be understood by those skilled in the art that various changes and modifications may be made without departing from the scope of the invention as defined in the following claims.

What is claimed is:

1. A method for charge-neutralizing a target substrate in a substrate processing apparatus including a chamber for accommodating the target substrate therein; and a mounting table for mounting the target substrate thereon, the mounting table having an electrostatic attraction portion for electrostatically attracting the target substrate; and a heat transfer gas supply system for injecting a heat transfer gas from the electrostatic attraction portion to the target substrate, the method comprising:
supplying an ionized gas from the heat transfer gas supply system to the target substrate.

2. The method of claim 1, wherein the mounting table has a separating unit by which the target substrate is separated from the electrostatic attraction portion, and
in the supplying of the ionized gas, the target substrate is separated from the electrostatic attraction portion by the separating unit.

3. The method of claim 1, wherein the heat transfer gas supply system includes a plurality of injection holes that are open toward the target substrate, and
in the supplying of the ionized gas, the ionized gas is supplied through the injection holes.

4. The method of claim 3, wherein, in the supplying of the ionized gas, a pressure around one surface of the target substrate on a side of the electrostatic attraction portion is set to be lower than a pressure around the other surface of the target substrate.

5. The method of claim 4, wherein, in the supplying of the ionized gas, the ionized gas is supplied through some of the injection holes, and a gas around the surface of the target substrate on the side of the electrostatic attraction portion is absorbed through the other injection holes.

6. The method of claim 5, wherein the electrostatic attraction portion has a circular plate shape, and the injection holes are dispersedly arranged over a surface of the circular plate; and
in the supplying of the ionized gas, the ionized gas is supplied through a group of the injection holes arranged at a peripheral portion of the surface of the circular plate, and a gas around the surface of the target substrate on the side of the electrostatic attraction portion is absorbed through a group of the injection holes arranged at a central portion of the surface of the circular plate.

7. The method of claim 5, wherein the electrostatic attraction portion has a circular plate shape, and the injection holes are dispersedly arranged over a surface of the circular plate; and
in the supplying of the ionized gas, the ionized gas is supplied through a group of the injection holes arranged at a central portion of the surface of the circular plate, and a gas around the surface of the target substrate on the side of the electrostatic attraction portion is absorbed through a group of the injection holes arranged at a peripheral portion of the surface of the circular plate.

8. The method of claim 2, wherein the heat transfer gas supply system includes a plurality of injection holes that are open toward the target substrate, and
in the supplying of the ionized gas, the ionized gas is supplied through the injection holes.

9. The method of claim 8, wherein, in the supplying of the ionized gas, a pressure around one surface of the target substrate on a side of the electrostatic attraction portion is set to be lower than a pressure around the other surface of the target substrate.

10. The method of claim 9, wherein, in the supplying of the ionized gas, the ionized gas is supplied through some of the injection holes, and a gas around the surface of the target substrate on the side of the electrostatic attraction portion is absorbed through the other injection holes.

11. The method of claim 10, wherein the electrostatic attraction portion has a circular plate shape, and the injection holes are dispersedly arranged over a surface of the circular plate; and
in the supplying of the ionized gas, the ionized gas is supplied through a group of the injection holes arranged at a peripheral portion of the surface of the circular plate, and a gas around the surface of the target substrate on the side of the electrostatic attraction portion is absorbed through a group of the injection holes arranged at a central portion of the surface of the circular plate.

12. The method of claim 10, wherein the electrostatic attraction portion has a circular plate shape, and the injection holes are dispersedly arranged over a surface of the circular plate; and
in the supplying of the ionized gas, the ionized gas is supplied through a group of the injection holes arranged at a central portion of the surface of the circular plate, and a gas around the surface of the target substrate on the side of the electrostatic attraction portion is absorbed through a group of the injection holes arranged at a peripheral portion of the surface of the circular plate.

13. The method of claim 1, wherein the heat transfer gas supply system includes through holes extending through the electrostatic attraction portion, and the ionized gas is supplied through the through holes.

14. The method of claim 2, wherein the heat transfer gas supply system includes through holes extending through the electrostatic attraction portion, and the ionized gas is supplied through the through holes.

15. A method for charge-neutralizing a target substrate in a substrate processing apparatus including a chamber for accommodating the target substrate therein; and a mounting table for mounting the target substrate thereon, the mounting table having an electrostatic attraction portion for electrostatically attracting the target substrate; a heat transfer gas supply system for injecting a heat transfer gas from the electrostatic attraction portion to the target substrate; and a separating unit by which the target substrate is separated from the electrostatic attraction portion, the method comprising:
supplying an ionized gas from the heat transfer gas supply system to the target substrate
wherein the substrate processing apparatus includes an irradiation unit for irradiating a soft X-ray or an UV (ultraviolet) beam toward an inside of the chamber; and
in the supplying of the ionized gas, the target substrate is separated from the electrostatic attraction portion by the separating unit, and a soft X-ray or an UV beam is irradiated from the irradiation unit toward a space between the target substrate and the electrostatic attraction portion.

16. A substrate processing apparatus including a chamber for accommodating the target substrate therein; and a mounting table for mounting the target substrate thereon, the mounting table having an electrostatic attraction portion for electrostatically attracting the target substrate, and a heat transfer gas supply system for injecting a heat transfer gas from the electrostatic attraction portion to the target substrate,
wherein an ionized gas is supplied from the heat transfer gas supply system to the target substrate.

17. A substrate processing apparatus including a chamber for accommodating the target substrate therein; and a mounting table for mounting the target substrate thereon, the mounting table having an electrostatic attraction portion for electrostatically attracting the target substrate; a heat transfer gas supply system for injecting a heat transfer gas from the electrostatic attraction portion to the target substrate; and a separating unit by which the target substrate is separated from the electrostatic attraction portion, the apparatus comprising:
an irradiation unit for irradiating a soft X-ray or an UV beam toward an inside of the chamber,
wherein a predetermined gas is supplied from the heat transfer gas supply system toward the target substrate; and
when the predetermined gas is supplied toward the target substrate, the target substrate is separated from the electrostatic attraction portion by the separating unit, and a soft X-ray or an UV beam is irradiated from the irradiation unit toward a space between the target substrate and the electrostatic attraction portion.
